(19) United States
(12) Patent Application Publication
(10) Pub. No.: US 2014/0281270 A1
(43) Pub. Date: Sep. 18, 2014

(54) MECHANISM TO IMPROVE INPUT/OUTPUT WRITE BANDWIDTH IN SCALABLE SYSTEMS UTILIZING DIRECTORY BASED COHERECY

(71) Applicants: Henk G. Neefs, Palo Alto, CA (US); Ganesh Kumar, Fort Collins, CO (US); Vedaraman Geetha, Fremont, CA (US); Jeffrey D. Chamberlain, Tracy, CA (US); Sailesh Kottapalli, San Jose, CA (US); Jeffrey S. Wilder, Olympia, WA (US)

(72) Inventors: Henk G. Neefs, Palo Alto, CA (US); Ganesh Kumar, Fort Collins, CO (US); Vedaraman Geetha, Fremont, CA (US); Jeffrey D. Chamberlain, Tracy, CA (US); Sailesh Kottapalli, San Jose, CA (US); Jeffrey S. Wilder, Olympia, WA (US)

(21) Appl. No.: 13/835,862

(22) Filed: Mar. 15, 2013

(51) Int. Cl. G06F 12/08

(52) U.S. Cl. CPC G06F 12/0815
USPC 711/143

(57) ABSTRACT

Methods and apparatus relating to directory based coherency to improve input/output write bandwidth in scalable systems are described. In one embodiment, a first agent receives a request to write data from a second agent via a link and logic causes the first agent to write the directory state to an Input/Output Directory Cache (IODC) of the first agent. Additionally, the logic causes the second agent to send data from a modified state to an exclusive state using write back to the first agent, while allowing the data to remain cached exclusively in the second agent and also enabling the deallocation of the IODC entry in the first agent. Other embodiments are also disclosed.

### FIELD

The present disclosure generally relates to the field of electronics. More particularly, an embodiment of the invention relates to a mechanism to improve input/output write bandwidth in scalable systems utilizing directory based coherency.

### BACKGROUND

Cache memory in computer systems may be kept coherent using a snoopy bus or a directory based protocol. In either case, a memory address is associated with a particular location in the system. This location is generally referred to as the “home node” of a memory address.

In a directory based protocol, processing/caching agents may send requests to a home node for access to a memory address with which a corresponding Home Agent (HA) is associated. Accordingly, performance of such computer systems may be directly dependent on how efficiently directory based coherency is managed.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of an embodiment of a computing systems, which can be utilized to implement various embodiments discussed herein.

FIG. 2 illustrates a block diagram of an embodiment of a computing system, which can be utilized to implement one or more embodiments discussed herein.

FIG. 3 illustrates a flow diagram according to an embodiment.

FIG. 4 illustrates a flow diagram according to an embodiment.

FIG. 5 illustrates a block diagram of an embodiment of a computing system, which can be utilized to implement one or more embodiments discussed herein.

FIG. 6 illustrates a block diagram of an embodiment of a computing system, which can be utilized to implement one or more embodiments discussed herein.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments. Various aspects of embodiments of the invention may be performed using various means, such as integrated semiconductor circuits (“hardware”), computer-readable instructions organized into one or more programs (“software”) or some combination of hardware and software. For the purposes of this disclosure reference to “logic” shall mean either hardware, software, or some combination thereof.

Some embodiments relate to directory based coherency to improve input/output write bandwidth, e.g., in scalable systems. In an embodiment, the write bandwidth is improved for write operations that are compliant with PCIe (Peripheral Component Interconnect express, e.g., in accordance with PCIe Base Specification, such as Revision 3.0, Nov. 10, 2010). For example, the memory bandwidth necessary for Input/Output (IO or I/O) write operations may be reduced, e.g., to improve overall processor/memory performance in various types of systems/platforms.

Generally, cache memory in computing systems may be kept coherent using a snoopy bus or a directory based protocol. In either case, a system memory address may be associated with a particular location in the system. This location is generally referred to as the “home node” of the memory address. In a directory based protocol, processing/caching agents may send requests to the home node for access to a memory address with which a “home agent” (or HA) is associated. Moreover, in distributed cache coherence protocols, caching agents (CAs) may send requests to home agents which control coherent access to corresponding memory spaces (e.g., a subset of the memory space is served by the collocated memory controller). Home agents are, in turn, responsible for ensuring that the most recent copy of the requested data is returned to the requestor either from memory or a caching agent which owns the requested data. The home agent may also be responsible for invalidating copies of data at other caching agents if the request is for an exclusive copy, for example. For these purposes, a home agent generally may snoop every caching agent or rely on a directory (e.g., directory cache 122 of FIG. 1 or a copy of a memory directory stored in a memory, such as memory 120 of FIG. 1) to track one or more caching agents where the data may reside. In an embodiment, the directory cache 122 may include a full or partial copy of the directory stored in the memory 120.

For these purposes, in a home snoop protocol based system, the home agent can either snoop every caching agent in the system all the time, or it can rely on a directory to track the location of the most recent data (i.e., if the data is most up to date in the memory or if the caching agents need to be snooped). Snooping every caching agent for every read request has the disadvantage that it increases interconnect bandwidth usage and power. In fact, in large scalable systems, under some application loads, the interconnect bandwidth usage could increase to the extent that it could get saturated and degrade system performance. Hence, enabling a directory is a useful mode of operation in large multi-socket systems. However, enabling a directory means that the directory has to be read and kept up to date to indicate the correct cache line state in the system. This means memory bandwidth use for directory reads and updates will take away from the application memory bandwidth.

Moreover, some implementations may utilize a directory based coherence engine/mechanism to track the location of data in the system, e.g., since the directory has the ability to reduce the amount of interconnect bandwidth required for snooping remote agents. One drawback of some directory implementations is that directory state may be stored in the same physical memory module as the data, and as a result read and write operations of the directory state require consumption of memory bandwidth. To this end, an IO Directory Cache (IODC) may be used to reduce the directory-related memory accesses for IO write transactions (such as the IODC 130 of FIG. 1, for example).

Furthermore, some embodiments improve the IO bandwidth in a directory based cache coherence system, e.g., in a scalable manner. An embodiment introduces a new WbMtoE (write-back Modified line to memory and keep an Exclusive copy of the line) leg to the flow for allocating PCIe write (generally referred to as PCIItoM which stands for request for ownership of the line without data from PCIe), allowing usage of an RTID (Request Transaction Index) indexed IO Directory Cache (IODC) to optimize the directory-related memory accesses for the allocating PCIe write flow. Furthermore, node IDs (NIDs) may be introduced into the IODC design to provide better scalability as the number of sockets increases. Additionally, power/link utilization heuristics may be used to allow the IODC to tradeoff coherency (snoops and snoop responses) bandwidth against memory bandwidth in a scalable fashion, while dynamically optimizing the memory bandwidth delivered to an application.

Generally, the IO write flow begins first with a request for ownership of a cache line from the agent attempting to perform the write. Since the IO has no intention of reading the cache line's pre-existing data, this flow uses the ownership request flow that does not require a read of the data (InvItoE, which stands for read of cache line ownership without needing data) which is then followed by a write of new data to the cache line. There are two types of IO write flows to consider: (i) the non-allocating flow (PCIWiL which stands for write invalidate line from PCIe), and (ii) the allocating flow (PCIItoM which provides ownership of the cache line to enable a future write). Both begin with the initial InvItoE, but differ in the way in which they perform the subsequent write. For the non-allocating flow, the IO write appears immediately at the home agent in the form of a WbMtoI (which stands for write-back modified cache line to memory and invalidate the line from requesting caching agent) because recently written data is not going to be cached in the socket's Last Level Cache (LLC). For the allocating flow, no write request appears immediately at the home agent because the write data is allocated in the socket's internal LLC in M state for immediate consumption. Allocating the line into the LLC is made in some implementations since it has the advantage that subsequent accesses to the line will result in LLC hits until the line is evicted from the LLC without requiring further participation of the home agent or the memory (e.g., Dynamic Random Access Memory (DRAM)).

In a directory based system, the InvItoE operation typically requires a memory read for obtaining the directory tags used to resolve coherency. A memory write operation to update the directory with new ownership is also required. Thus, the InvItoE requires two memory operations for a transaction that does not return data to the requestor. In a snoopy system, the same transaction will not result in any memory operation since snoops are unconditionally broadcast to resolve coherency, and there is no directory to update. However, snoopy systems are not scalable; hence, larger systems tend to be directory based. The memory operations necessary for InvItoE (directory read followed by a directory write) significantly reduce the application memory bandwidth during IO write flows in directory based systems. An IODC structure in the home agent can be used to address this memory bandwidth loss. In processors where the InvItoE and the corresponding WbMtoI are treated internally by the processor issuing the write as a single continuous flow using the same transaction ID (RTID), a direct mapped cache indexed by the RTID can be used to hold the InvItoE transaction. The memory operations necessary for the InvItoE can be replaced by snoop broadcast to ensure no other caching agent has a copy of the line. When all the snoop responses are received, the InvItoE transaction can complete without any memory lookup or update as long as the InvItoE transaction remains cached in the IODC. The IODC holds the latest directory state of the InvItoE cache line, while the directory state in the memory is stale. The IODC is looked up for incoming transactions (e.g., address CAMed, where CAM stands for Content Addressable Memory) to determine if they hit in the IODC. If there is a hit in the IODC, the directory state is not reliable for the incoming transaction and hence snoops need to be broadcast (or alternatively, more exact directory information from the directory cache can be used for targeted snooping). The IODC hit can be used to skip the memory read for the incoming transaction further saving memory bandwidth. In turn, the InvItoE is deallocated from the IODC when the corresponding WbMtoI comes in and hits in the IODC. The RTID index based IODC works because the InvItoE and the following WbMtoI use the same RTID and no other intervening transaction from the same caching agent uses that same RTID.

While this simple RTID index based IODC works well with non-allocating flow where the InvItoE does not allocate into the LLC, which results in the WbMtoI coming to the home agent, it does not work for the allocating flow. In the allocating flow, the processor allocates the cache line into the LLC in the M-state after completing the InvItoE and hence no subsequent write comes to the home agent when the PCIe write flow completes. As explained previously, the simple RTID based IODC works because the ownership request and the following write come to the home agent using the same RTID with no other intervening transaction using that same RTID. To this end, an embodiment addresses this problem by introducing a WbMtoE flow leg to the allocating PCIe write flow.

To this end, an embodiment modifies the allocating write flow (discussed above), so that the initial request for ownership is still followed by an immediate write to the home agent using the same RTID. This satisfies the requirements of the IODC, while still allowing the write data to remain cached in the processor by using a WbMtoE rather than a WbMtoI. So, rather than silently keeping the data cached after issuing the InvItoE, the processor will instead issue a WbMtoE to the home agent while allocating its own copy of that data in its LLC in E (Exclusive) state. The purpose of including this extra write to the first ownership request of the PCIe allocating write flow is to support the requirements of the IODC. It seems wasteful if one only thinks of the reads and writes to memory in terms of the data, but as previously mentioned, since directory read and writes also have to access memory (e.g., DRAM), it actually has the potential to save memory bandwidth significantly overall by allowing the home agent to eliminate unnecessary directory accesses.

In one embodiment, a hint bit is added to InvItoE transactions to indicate to the IODC that this is an InvItoE transaction that originated as part of a PCIe write flow. That hint serves as the signal to the home agent that it is safe to skip the directory cache update and allocate into the IODC instead. Hence, the processor is indicating (when it sets this hint bit) that the InvItoE will be followed by a WbMto* transaction using the same RTID. Furthermore, the IODC may be scalable to large multi-socket systems with multiple IOs with the inclusion of the node ID (NID, where IO and socket can share the same NID) tracking in the IODC. In this case, one or more RTIDs from various NIDs may map to the same IODC entry, and hashing between NID and RTID may then be used to index into the IODC for better utilization of the IODC entries. In an embodiment, when multiple IO transactions map to the same IODC entry for allocation, the first one is allocated into the IODC, and all subsequent ones will find the IODC entry to already be valid and hence follow the normal flow like the IODC did not exist (i.e., perform memory accesses for directory read and update). The introduction of NID in the IODC trades-off IODC area/power for potentially additional performance upside.

Additionally, for large socket systems and non-fully connected topologies, where unmetered snoop broadcast could flood the system with snoops and responses impacting system performance and bandwidth, an embodiment provides a mechanism where IODC allocation can be gated by consulting with Opportunistic Snoop Broadcast (OSB) heuristics. OSB provides heuristics to allow controlled snoop broadcasting to improve application memory bandwidth when it is beneficial to broadcast snoop over looking up the directory tags in memory. Since IODC allocation results in snoop broadcast for the InvItoE transaction, the OSB heuristics which determines if there is enough interconnect bandwidth available can be used to gate IODC allocation. If OSB heuristics indicates that there is not enough interconnect bandwidth available, the InvItoE is not allocated in the IODC, and instead the memory is read and updated with new directory information. This results in a dynamic trade-off between interconnect bandwidth and memory bandwidth, allowing the opportunity to enable the IODC even for large socket systems without impacting performance and bandwidth due to excessive snooping. Note that such a dynamic trade-off mechanism is also applicable to the implementation variation where the snoops would be targeted to a caching agent or a subgroup of caching agents (e.g., instead of broadcast to all agents under directory control).

Various computing systems may be used to implement embodiments, discussed herein, such as the systems discussed with reference to FIGS. 1-2 and 5-6. More particularly, FIG. 1 illustrates a block diagram of a computing system 100, according to an embodiment of the invention. The system 100 may include one or more agents 102-1 through 102-M (collectively referred to herein as “agents 102” or more generally “agent 102”). In an embodiment, one or more of the agents 102 may be any of components of a computing system, such as the computing systems discussed with reference to FIGS. 5-6.

As illustrated in FIG. 1, the agents 102 may communicate via a network fabric 104. In one embodiment, the network fabric 104 may include a computer network that allows various agents (such as computing devices) to communicate data. In an embodiment, the network fabric 104 may include one or more interconnects (or interconnection networks) that communicate via a serial (e.g., point-to-point) link and/or a shared communication network (which may be configured as a ring in an embodiment). For example, some embodiments may facilitate component debug or validation on links that allow communication with Fully Buffered Dual in-line memory modules (FBD), e.g., where the FBD link is a serial link for coupling memory modules to a host controller device (such as a processor or memory hub). Debug information may be transmitted from the FBD channel host such that the debug information may be observed along the channel by channel traffic trace capture tools (such as one or more logic analyzers).

In one embodiment, the system 100 may support a layered protocol scheme, which may include a physical layer, a link layer, a routing layer, a transport layer, and/or a protocol layer. The fabric 104 may further facilitate transmission of data (e.g., in form of packets) from one protocol (e.g., caching processor or caching aware memory controller) to another protocol for a point-to-point or shared network. Also, in some embodiments, the network fabric 104 may provide communication that adheres to one or more cache coherent protocols.

Furthermore, as shown by the direction of arrows in FIG. 1, the agents 102 may transmit and/or receive data via the network fabric 104. Hence, some agents may utilize a unidirectional link while others may utilize a bidirectional link for communication. For instance, one or more agents (such as agent 102-M) may transmit data (e.g., via a unidirectional link 106), other agent(s) (such as agent 102-2) may receive data (e.g., via a unidirectional link 108), while some agent(s) (such as agent 102-1) may both transmit and receive data (e.g., via a bidirectional link 110).

Additionally, at least one of the agents 102 may be a home agent and one or more of the agents 102 may be requesting or caching agents as will be further discussed herein. As shown, at least one agent (only one shown for agent 102-1) may include or have access to one or more logics (or engines) 111 to provide directory based coherency to improve input/output write bandwidth in scalable systems, as discussed herein, e.g., with reference to FIGS. 1-6. Further, in an embodiment, one or more of the agents 102 (only one shown for agent 102-1) may have access to a memory (which may be dedicated to the agent or shared with other agents) such as memory 120. Also, one or more of the agents 102 (only one shown for agent 102-1) may maintain entries in one or more storage devices (only one shown for agent 102-1, such as directory cache(s) 122 and/or IODC 130, e.g., implemented as a table, queue, buffer, linked list, etc.) to track information about items stored/maintained by the agent 102-1 (as a home agent) and/or other agents (including CAs for example) in the system. In some embodiments, each (or at least one) of the agents 102 may be coupled to the memory 120, a corresponding directory cache 122, and/or IODC 130 that are either on the same die as the agent or otherwise accessible by the agent.

FIG. 2 is a block diagram of a computing system 200 in accordance with an embodiment. System 200 includes a plurality of sockets 202-208 (four shown but some embodiments can have more or less socket). Each socket includes a processor and one or more of logic 111 and/or directory cache 122. In some embodiments, logic 111, IODC 130, and/or directory cache 122 can be present in one or more components of system 200 (such as those shown in FIG. 2). Further, more or less 111, IODC 130, and/or 122 blocks are present in a system depending on the implementation. Additionally, each socket is coupled to the other sockets via a point-to-point (PtP) link, or a differential interconnect, such as a Quick Path Interconnect (QPI), MIPI (Mobile Industry Processor Interface), etc. As discussed with respect the network fabric 104 of FIG. 1, each socket is coupled to a local portion of system memory, e.g., formed by a plurality of Dual Inline Memory Modules (DIMMs) that include dynamic random access memory (DRAM).

In another embodiment, the network fabric may be utilized for any System on Chip (SoC or SOC) application, utilize custom or standard interfaces, such as, ARM compliant interfaces for AMBA (Advanced Microcontroller Bus Architecture), OCP (Open Core Protocol), MIPI (Mobile Industry Processor Interface), PCI (Peripheral Component Interconnect) or PCIe (Peripheral Component Interconnect Express).

Some embodiments use a technique that enables use of heterogeneous resources, such as AXI/OCP technologies, in a PC (Personal Computer) based system such as a PCI-based system without making any changes to the IP resources themselves. Embodiments provide two very thin hardware blocks, referred to herein as a Yunit and a shim, that can be used to plug AXI/OCP IP into an auto-generated interconnect fabric to create PCI-compatible systems. In one embodiment a first (e.g., a north) interface of the Yunit connects to an adapter block that interfaces to a PCI-compatible bus such as a direct media interface (DMI) bus, a PCI bus, or a Peripheral Component Interconnect Express (PCIe) bus. A second (e.g., south) interface connects directly to a non-PC interconnect, such as an AXI/OCP interconnect. In various implementations, this bus may be an OCP bus.

In some embodiments, the Yunit implements PCI enumeration by translating PCI configuration cycles into transactions that the target IP can understand. This unit also performs address translation from re-locatable PCI addresses into fixed AXI/OCP addresses and vice versa. The Yunit may further implement an ordering mechanism to satisfy a producer-consumer model (e.g., a PCI producer-consumer model). In turn, individual IPs are connected to the interconnect via dedicated PCI shims. Each shim may implement the entire PCI header for the corresponding IP. The Yunit routes all accesses to the PCI header and the device memory space to the shim. The shim consumes all header read/write transactions and passes on other transactions to the IP. In some embodiments, the shim also implements all power management related features for the IP.

Thus, rather than being a monolithic compatibility block, embodiments that implement a Yunit take a distributed approach. Functionality that is common across all IPs, e.g., address translation and ordering, is implemented in the Yunit, while IP-specific functionality such as power management, error handling, and so forth, is implemented in the shims that are tailored to that IP.

In this way, a new IP can be added with minimal changes to the Yunit. For example, in one implementation the changes may occur by adding a new entry in an address redirection table. While the shims are IP-specific, in some implementations a large amount of the functionality (e.g., more than 90%) is common across all IPs. This enables a rapid reconfiguration of an existing shim for a new IP. Some embodiments thus also enable use of auto-generated interconnect fabrics without modification. In a point-to-point bus architecture, designing interconnect fabrics can be a challenging task. The Yunit approach described above leverages an industry ecosystem into a PCI system with minimal effort and without requiring any modifications to industry-standard tools.

As shown in FIG. 2, each socket is coupled to a Memory Controller (MC)/Home Agent (HA) (such as MC0/HA0 through MC3/HA3). The memory controllers are coupled to a corresponding local memory (labeled as MEM0 through MEM3), which can be a portion of system memory (such as memory 512 of FIG. 5). In some embodiments, the memory controller (MC)/Home Agent (HA) (such as MC0/HA0 through MC3/HA3) can be the same or similar to agent 102-1 of FIG. 1 and the memory, labeled as MEM0 through MEM3, can be the same or similar to memory devices discussed with reference to any of the figures herein. Generally, processing/caching agents send requests to a home node for access to a memory address with which a corresponding “home agent” is associated. Also, in one embodiment, MEM0 through MEM3 can be configured to mirror data, e.g., as master and slave. Also, one or more components of system 200 can be included on the same integrated circuit die in some embodiments.

Furthermore, one implementation (such as shown in FIG. 2) is for a socket glueless configuration with mirroring. For example, data assigned to a memory controller (such as MC0/HA0) is mirrored to another memory controller (such as MC3/HA3) over the PtP links.

Operations discussed with reference to FIGS. 3-4 may be performed by one or more components discussed with reference to FIG. 1, 2, 5, or 6. As discussed herein (e.g., with reference to FIGS. 3-4), “CPU” refers to Central Processing Unit, processor, or processor core, “HA” refers to Home Agent, “I” refers to an invalid cache state (or locally cached), “A” refers to snoop all, “S” refers to a shared cache state (in one or more caching agents), “F” refers to a forward cache state, “M” refers to a modified cache state, “E” refers to an exclusive cache state, “GntE_Cmp” refers to InvItoE completion signal, “MemRd” refers to a memory read operation, “MemWr” refers to a memory write operation, “RdData” refers to a data read operation, “SnpData” refers to snoop data, “SnpinvItoE” refers to snooping on behalf of InvItoE request, “Rspl” refers to response from CA that the line has been invalidated in its cache in response to the snoop, “WbIData” refers to write-back of modified data to memory leaving an invalid copy in the cache, “WbSData” refers to write back shared data, “WbMtoE” refers to write back of modified data to memory leaving an exclusive copy in the cache, “WbEData” refers to write back exclusive data, “DataC_F” refers to data returned in F state, “Dir” refers to memory directory or IODC (such as discussed with reference to FIG. 1), “Cmp” refers to a completion signal, “GntE_Cmp” refers to InvItoE completion signal, “RspFwdSWb” refers to response forward shared writeback, and “DataC_E_Cmp” refers to a completion signal with date returned in E state (DataC_E).

More specifically, FIG. 3 illustrates a flow diagram for IODC allocation saving directory-related memory read and update operations in non-allocating PCIe write flow, according to an embodiment. FIG. 4 illustrates a flow diagram for IODC allocation saving directory-related memory read operation in allocating PCIe write flow, according to an embodiment. Accordingly, some embodiments extend the directory-related memory read and update savings to include both non-allocating and allocating (e.g., where only memory read operation is saved) PCIe write flows. The new WbMtoE leg is introduced to the allocating flow in order to enable these PCIe writes to also satisfy the requirements of an RTID-indexed IODC. Moreover, both external IO (TO caching agent with own NID) and integrated IO (TO transactions made visible by core centric caching agents) are addressed. And, saving directory-related memory read and update bandwidth for the IO write are also explicitly addressed. For example, the IODC is allowed to be small by introducing the node identifier (NID) as part of the tag in the IODC; thus, making it scalable to large multi-socket systems with multiple IOs. Additionally, a mechanism is provided to gate the IODC allocation by consulting with OSB heuristics to trade-off between interconnect bandwidth and memory bandwidth, allowing the opportunity to enable the IODC even for large socket systems, e.g., without impacting performance and bandwidth due to excessive snooping.

An embodiment modifies the allocating write flow, so that the initial request for ownership is still followed by an immediate write to the home agent using the same RTID. This satisfies the requirements of the IODC while still allowing the write data to remain cached in the processor by using a WbMtoE rather than a WbMtoI. So, rather than silently keeping the data cached after issuing the InvItoE, the processor will instead issue a WbMtoE to the home agent while allocating its own copy of that data in its LLC in E state. The purpose of including this extra write to the first ownership request of the PCIe allocating write flow (shown in FIG. 4) is to support the requirements of the IODC. It seems wasteful if one only thinks of the reads and writes to memory in terms of the data, but as previously mentioned, since directory read and writes also have to access memory (e.g., DRAM), it actually has the potential to save memory bandwidth significantly overall by allowing the home agent to eliminate unnecessary directory accesses.

In one embodiment, a hint bit is added to InvItoE transactions to indicate to the IODC that this is an InvItoE transaction that originated as part of a PCIe write flow. That hint serves as the signal to the home agent that it is safe to skip the directory update and allocate into the IODC instead. Hence, the processor is indicating (when it sets this hint bit) that the InvItoE will be followed by a WbMto* transaction using the same RTID. The IODC may be scalable to large multi-socket systems with multiple IOs with the inclusion of the node ID (NID) tracking in the IODC. In this case, RTIDs from various NIDs map to the same IODC entry, hashing between NID and RTID may then be used to index into the IODC for better utilization of the IODC entries. In an embodiment, when multiple IO transactions map to the same IODC entry for allocation, the first one is allocated into the IODC, and all subsequent ones will find the IODC entry to already be valid and hence follow the normal flow like the IODC did not exist (i.e., perform memory accesses for directory read and update). The introduction of NID in the IODC trades-off IODC area/power for potentially additional performance upside.

Additionally, for large socket systems and non-fully connected topologies where unmetered snoop broadcast could flood the system with snoops and responses impacting system performance and bandwidth, an embodiment provides a mechanism where IODC allocation can be gated by consulting with Opportunistic Snoop Broadcast (OSB) heuristics. OSB provides heuristics to allow controlled snoop broadcasting to improve application memory bandwidth when it is beneficial to broadcast snoop over looking up the directory tags in memory. Since IODC allocation results in snoop broadcast for the InvItoE transaction, the OSB heuristics which determines if there is enough interconnect bandwidth available can be used to gate IODC allocation. If OSB heuristics indicates that there is not enough interconnect bandwidth available, the InvItoE is not allocated in the IODC, and instead the memory is read and updated with new directory information. This results in a dynamic trade-off between interconnect bandwidth and memory bandwidth, allowing the opportunity to enable the IODC even for large socket systems without impacting performance and bandwidth due to excessive snooping. Note that such a dynamic trade-off mechanism is also applicable to the implementation variation where the snoops would be targeted to a caching agent or a subgroup of caching agents (e.g., instead of broadcast to all agents under directory control).

Furthermore, an embodiment introduces a novel way of implementing the allocating PCIe write flow that allows the use of a simple RTID indexed IODC to reduce directory-related memory lookup and update necessary for the IO writes, thus improving application memory bandwidth. Current allocating PCIe write flows generally involve an InvItoE that brings in a cache line into the LLC in the M state, followed by a write that hits in the LLC. This flow does not lend itself to be used with the simple RTID indexed IODC to save memory lookup and update accesses because the initial write to the allocated cache line is not visible to the home agent. One embodiment introduces a new WbMtoE flow for the case where the allocating write has to request ownership from the home agent, and thereby allows the PCIe write flow's InvItoE transactions to allocate the cache line in the E state in the LLC and issue WbMtoE and WbEData to the home agent. This allows the InvItoE to be allocated in the IODC, enabling snoop broadcast instead of memory lookup to read the directory information. The WbMtoE to the same RTID guarantees that the IODC entry allocated by the InvItoE will be deallocated cleanly. Without such embodiments, in a directory based system, the PCIe write flow will waste significant memory bandwidth on directory reads and updates to the DRAM, reducing the effective memory bandwidth available to the application. An alternative way to reduce the directory-related memory lookup and update would be to implement a snoopy system but such solutions are not scalable to large numbers of sockets. Yet another alternative would be to only use the non-allocating PCIe write flow with the IODC, but this would be a significant performance detriment as well because the allocating write flows are highly preferred by IO devices due to the large performance benefit available when the IO is able to keep its recently written data cached locally.

FIG. 5 illustrates a block diagram of an embodiment of a computing system 500. One or more of the agents 102 of FIG. 1 may comprise one or more components of the computing system 500. Also, various components of the system 500 may include a directory cache (e.g., such as directory cache 122 of FIG. 1), IODC 130, and/or a logic (such as logic 111 of FIG. 1) as illustrated in FIG. 5. However, the directory cache, IODC, and/or logic may be provided in locations throughout the system 500, including or excluding those illustrated. The computing system 500 may include one or more central processing unit(s) (CPUs) 502 (which may be collectively referred to herein as “processors 502” or more generically “processor 502”) coupled to an interconnection network (or bus) 504. The processors 502 may be any type of processor such as a general purpose processor, a network processor (which may process data communicated over a computer network 505), etc. (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors.

The processor 502 may include one or more caches (e.g., other than the illustrated directory caches 122/130), which may be private and/or shared in various embodiments. Generally, a cache stores data corresponding to original data stored elsewhere or computed earlier. To reduce memory access latency, once data is stored in a cache, future use may be made by accessing a cached copy rather than refetching or recomputing the original data. The cache(s) may be any type of cache, such a level 1 (L1) cache, a level 2 (L2) cache, a level 3 (L3), a mid-level cache, a last level cache (LLC), etc. to store electronic data (e.g., including instructions) that is utilized by one or more components of the system 500. Additionally, such cache(s) may be located in various locations (e.g., inside other components to the computing systems discussed herein, including systems of FIG. 1, 2, 5, or 6).

A chipset 506 may additionally be coupled to the interconnection network 504. Further, the chipset 506 may include a graphics memory control hub (GMCH) 508. The GMCH 508 may include a memory controller 510 that is coupled to a memory 512. The memory 512 may store data, e.g., including sequences of instructions that are executed by the processor 502, or any other device in communication with components of the computing system 500. Also, in one embodiment of the invention, the memory 512 may include one or more volatile storage (or memory) devices such as random access memory (RAM), dynamic RAM (DRAM), synchronous DRAM (SDRAM), static RAM (SRAM), etc. Nonvolatile memory may also be utilized such as a hard disk. Additional devices may be coupled to the interconnection network 504, such as multiple processors and/or multiple system memories.

The GMCH 508 may further include a graphics interface 514 coupled to a display device 516 (e.g., via a graphics accelerator in an embodiment). In one embodiment, the graphics interface 514 may be coupled to the display device 516 via an accelerated graphics port (AGP). In an embodiment of the invention, the display device 516 (such as a flat panel display) may be coupled to the graphics interface 514 through, for example, a signal converter that translates a digital representation of an image stored in a storage device such as video memory or system memory (e.g., memory 512) into display signals that are interpreted and displayed by the display 516.

As shown in FIG. 5, a hub interface 518 may couple the GMCH 508 to an input/output control hub (ICH) 520. The ICH 520 may provide an interface to input/output (I/O) devices coupled to the computing system 500. The ICH 520 may be coupled to a bus 522 through a peripheral bridge (or controller) 524, such as a peripheral component interconnect (PCI) bridge that may be compliant with the PCIe specification, a universal serial bus (USB) controller, etc. The bridge 524 may provide a data path between the processor 502 and peripheral devices. Other types of topologies may be utilized. Also, multiple buses may be coupled to the ICH 520, e.g., through multiple bridges or controllers. Further, the bus 522 may comprise other types and configurations of bus systems. Moreover, other peripherals coupled to the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), etc.

The bus 522 may be coupled to an audio device 526, one or more disk drive(s) 528, and a network adapter 530 (which may be a NIC in an embodiment). In one embodiment, the network adapter 530 or other devices coupled to the bus 522 may communicate with the chipset 506. Also, various components (such as the network adapter 530) may be coupled to the GMCH 508 in some embodiments of the invention. In addition, the processor 502 and the GMCH 508 may be combined to form a single chip. In an embodiment, the memory controller 510 may be provided in one or more of the CPUs 502. Further, in an embodiment, GMCH 508 and ICH 520 may be combined into a Peripheral Control Hub (PCH).

Additionally, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media capable of storing electronic data (e.g., including instructions).

The memory 512 may include one or more of the following in an embodiment: an operating system (O/S) 532, application 534, directory 501, and/or device driver 536. The memory 512 may also include regions dedicated to Memory Mapped I/O (MMIO) operations. Programs and/or data stored in the memory 512 may be swapped into the disk drive 528 as part of memory management operations. The application(s) 534 may execute (e.g., on the processor(s) 502) to communicate one or more packets with one or more computing devices coupled to the network 505. In an embodiment, a packet may be a sequence of one or more symbols and/or values that may be encoded by one or more electrical signals transmitted from at least one sender to at least on receiver (e.g., over a network such as the network 505). For example, each packet may have a header that includes various information which may be utilized in routing and/or processing the packet, such as a source address, a destination address, packet type, etc. Each packet may also have a payload that includes the raw data (or content) the packet is transferring between various computing devices over a computer network (such as the network 505).

In an embodiment, the application 534 may utilize the O/S 532 to communicate with various components of the system 500, e.g., through the device driver 536. Hence, the device driver 536 may include network adapter 530 specific commands to provide a communication interface between the O/S 532 and the network adapter 530, or other I/O devices coupled to the system 500, e.g., via the chipset 506.

In an embodiment, the O/S 532 may include a network protocol stack. A protocol stack generally refers to a set of procedures or programs that may be executed to process packets sent over a network 505, where the packets may conform to a specified protocol. For example, TCP/IP (Transport Control Protocol/Internet Protocol) packets may be processed using a TCP/IP stack. The device driver 536 may indicate the buffers in the memory 512 that are to be processed, e.g., via the protocol stack.

The network 505 may include any type of computer network. The network adapter 530 may further include a direct memory access (DMA) engine, which writes packets to buffers (e.g., stored in the memory 512) assigned to available descriptors (e.g., stored in the memory 512) to transmit and/or receive data over the network 505. Additionally, the network adapter 530 may include a network adapter controller, which may include logic (such as one or more programmable processors) to perform adapter related operations. In an embodiment, the adapter controller may be a MAC (media access control) component. The network adapter 530 may further include a memory, such as any type of volatile/nonvolatile memory (e.g., including one or more cache(s) and/or other memory types discussed with reference to memory 512).

FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-5 may be performed by one or more components of the system 600.

As illustrated in FIG. 6, the system 600 may include several processors, of which only two, processors 602 and 604 are shown for clarity. The processors 602 and 604 may each include a local memory controller hub (GMCH) 606 and 608 to enable communication with memories 610 and 612. The memories 610 and/or 612 may store various data such as those discussed with reference to the memory 612 of FIG. 6. As shown in FIG. 6, the processors 602 and 604 (or other components of system 600 such as chipset 620, I/O devices 643, etc.) may also include one or more cache(s) such as those discussed with reference to FIGS. 1-6.

In an embodiment, the processors 602 and 604 may be one of the processors 602 discussed with reference to FIG. 6. The processors 602 and 604 may exchange data via a point-to-point (PtP) interface 614 using PtP interface circuits 616 and 618, respectively. Also, the processors 602 and 604 may each exchange data with a chipset 620 via individual PtP interfaces 622 and 624 using point-to-point interface circuits 626, 628, 630, and 632. The chipset 620 may further exchange data with a high-performance graphics circuit 634 via a high-performance graphics interface 636, e.g., using a PtP interface circuit 637.

In at least one embodiment, a directory cache and/or logic may be provided in one or more of the processors 602, 604 and/or chipset 620. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6. For example, various components of the system 600 may include a directory cache (e.g., such as directory cache 122 of FIG. 1), IODC 130, and/or a logic (such as logic 111 of FIG. 1). However, the directory cache, IODC, and/or logic may be provided in locations throughout the system 600, including or excluding those illustrated.

The chipset 620 may communicate with the bus 640 using a PtP interface circuit 641. The bus 640 may have one or more devices that communicate with it, such as a bus bridge 642 and I/O devices 643. Via a bus 644, the bus bridge 642 may communicate with other devices such as a keyboard/mouse 645, communication devices 646 (such as modems, network interface devices, or other communication devices that may communicate with the computer network 605), audio I/O device, and/or a data storage device 648. The data storage device 648 may store code 649 that may be executed by the processors 602 and/or 604.

The following examples pertain to further embodiments. Example 1 includes an apparatus comprising: logic to cause a first agent, which is to receive a request to write data from a second agent via a link, to write a directory state of a cache line, corresponding to the data, to an Input/Output Directory Cache (IODC) of the first agent and write the data to a memory coupled to the first agent, wherein writing the data from the second agent is to comprise a read for ownership operation and a write operation and wherein the read for ownership operation is to cache the directory state in the IODC and the write operation is to write back the data to the memory of the first agent and cause deallocation of the cache line from the IODC while keeping the cache line in a cache of the second agent in an exclusive state. In example 2, the subject matter of example 1 can optionally include an apparatus, wherein the logic is to cause caching of the directory state of the cache line in the IODC until the data is written back to save directory lookup read and update write to memory for the read for ownership operation. In example 3, the subject matter of example 1 can optionally include an apparatus, wherein each entry of the IODC is to store a node identifier that identifies an input/output node. In example 4, the subject matter of example 3 can optionally include an apparatus, wherein one or more request transaction indexes from various node identifiers are to map to a same IODC entry. In example 5, the subject matter of example 4 can optionally include an apparatus, wherein the node identifier and the one or more request transaction indexes are to be hashed to index into the IODC. In example 6, the subject matter of example 1 can optionally include an apparatus, wherein allocation into the IODC is to be controlled based on opportunistic snoop broadcast heuristics. In example 7, the subject matter of example 1 can optionally include an apparatus, wherein the first agent is to maintain a directory, the directory to store information about at which agent and in what state each cache line is cached. In example 8, the subject matter of example 1 can optionally include an apparatus, wherein the first agent is to comprise the logic. In example 9, the subject matter of example 1 can optionally include an apparatus, wherein the first agent and the second agent are on a same integrated circuit die. In example 10, the subject matter of example 1 can optionally include an apparatus, wherein the link is to comprise a point-to-point interconnect. In example 11, the subject matter of example 1 can optionally include an apparatus, wherein one or more of the first agent or the second agent are to comprise a plurality of processor cores. In example 12, the subject matter of example 1 can optionally include an apparatus, wherein one or more of the first agent or the second agent are to comprise a plurality of sockets. In example 13, the subject matter of example 1 can optionally include an apparatus, wherein the second agent is to comprise an I/O (IO) device.

Example 14 includes a method comprising: receiving at a first agent a request to write data from a second agent via a link; and causing the first agent to write a directory state of a cache line, corresponding to the data, to an Input/Output Directory Cache (IODC) of the first agent and write the data to a memory coupled to the first agent, wherein writing the data from the second agent comprises a read for ownership operation and a write operation and wherein the read for ownership operation caches the directory state in the IODC and the write operation writes back the data to the memory of the first agent and cause deallocation of the cache line from the IODC while keeping the cache line in a cache of the second agent in an exclusive state. In example 15, the subject matter of example 14 can optionally include a method, further comprising causing caching of the directory state of the cache line in the IODC until the data is written back to save directory lookup read and update write to memory for the read for ownership operation. In example 16, the subject matter of example 14 can optionally include a method, further comprising each entry of the IODC storing a node identifier that identifies an input/output node. In example 17, the subject matter of example 16 can optionally include a method, further comprising mapping one or more request transaction indexes from various node identifiers to a same IODC entry. In example 18, the subject matter of example 17 can optionally include a method, further comprising hashing the node identifier and the one or more request transaction indexes to index into the IODC. In example 19, the subject matter of example 14 can optionally include a method, further comprising controlling allocation into the IODC based on opportunistic snoop broadcast heuristics. In example 20, the subject matter of example 14 can optionally include a method, further comprising the first agent maintaining a directory, the directory to store information about at which agent and in what state each cache line is cached. In example 21, the subject matter of example 14 can optionally include a method, wherein the link comprises a point-to-point interconnect. In example 22, the subject matter of example 14 can optionally include a method, wherein the second agent comprises an I/O (IO) device.

Example 23 includes a computer-readable medium comprising one or more instructions that when executed on a processor configure the processor to perform one or more operations of any of examples 14 to 22.

Examples 24 includes a system comprising: a processor having a first agent and a second agent; and logic, coupled to the processor, to cause the first agent, which is to receive a request to write data from the second agent via a link, to write a directory state of a cache line, corresponding to the data, to an Input/Output Directory Cache (IODC) of the first agent and write the data to a memory coupled to the first agent, wherein writing the data from the second agent is to comprise a read for ownership operation and a write operation and wherein the read for ownership operation is to cache the directory state in the IODC and the write operation is to write back the data to the memory of the first agent and cause deallocation of the cache line from the IODC while keeping the cache line in a cache of the second agent in an exclusive state. In example 25 the subject matter of example 24 can optionally include a system, wherein the logic is to cause caching of the directory state of the cache line in the IODC until the data is written back to save directory lookup read and update write to memory for the read for ownership operation. In example 26 the subject matter of example 24 can optionally include a system, wherein each entry of the IODC is to store a node identifier that identifies an input/output node. In example 27 the subject matter of example 26 can optionally include a system, wherein one or more request transaction indexes from various node identifiers are to map to a same IODC entry. In example 28 the subject matter of example 27 can optionally include a system, wherein the node identifier and the one or more request transaction indexes are to be hashed to index into the IODC. In example 29 the subject matter of example 24 can optionally include a system, wherein allocation into the IODC is to be controlled based on opportunistic snoop broadcast heuristics. In example 30 the subject matter of example 24 can optionally include a system, wherein the first agent is to maintain a directory, the directory to store information about at which agent and in what state each cache line is cached. In example 31 the subject matter of example 24 can optionally include a system, wherein the first agent is to comprise the logic. In example 32 the subject matter of example 24 can optionally include a system, wherein the first agent and the second agent are on a same integrated circuit die. In example 33 the subject matter of example 24 can optionally include a system, wherein the link is to comprise a point-to-point interconnect. In example 34 the subject matter of example 24 can optionally include a system, wherein one or more of the first agent or the second agent are to comprise a plurality of processor cores. In example 35 the subject matter of example 24 can optionally include a system, wherein one or more of the first agent or the second agent are to comprise a plurality of sockets. In example 36 the subject matter of example 24 can optionally include a system, wherein the second agent is to comprise an I/O (TO) device.

Example 37 includes an apparatus to improve input/output write bandwidth in scalable systems utilizing directory based coherency, the apparatus comprising: means for receiving at a first agent a request to write data from a second agent via a link; and means for causing the first agent to write a directory state of a cache line, corresponding to the data, to an Input/Output Directory Cache (IODC) of the first agent and write the data to a memory coupled to the first agent, wherein means for writing the data from the second agent comprises a read for ownership operation and a write operation and wherein the read for ownership operation is to cache the directory state in the IODC and the write operation is to write back the data to the memory of the first agent and cause deallocation of the cache line from the IODC while keeping the cache line in a cache of the second agent in an exclusive state. In example 38, the subject matter of example 37 can optionally include an apparatus, further comprising means for causing caching of the directory state of the cache line in the IODC until the data is written back to save directory lookup read and update write to memory for the read for ownership operation. In example 39, the subject matter of example 37 can optionally include an apparatus, further comprising means for each entry of the IODC storing a node identifier that identifies an input/output node. In example 40, the subject matter of example 37 can optionally include an apparatus, further comprising means for mapping one or more request transaction indexes from various node identifiers to a same IODC entry. In example 41, the subject matter of example 40 can optionally include an apparatus, further comprising means for hashing the node identifier and the one or more request transaction indexes to index into the IODC. In example 42, the subject matter of example 37 can optionally include an apparatus, further comprising means for controlling allocation into the IODC based on opportunistic snoop broadcast heuristics. In example 43, the subject matter of example 37 can optionally include an apparatus, further comprising means for maintaining a directory, the directory to store information about at which agent and in what state each cache line is cached. In example 44, the subject matter of example 37 can optionally include an apparatus, wherein the link is to comprise a point-to-point interconnect. In example 45, the subject matter of example 37 can optionally include an apparatus, wherein the second agent is to comprise an I/O (IO) device.

Example 46 includes an apparatus of any of examples 1 to 10 and 12, wherein one or more of the first agent or the second agent are to comprise a plurality of processor cores and wherein the second agent is to comprise an I/O (IO) device.

Example 47 includes an apparatus comprising: a receiving agent including an Input/Output Directory Cache (IODC) and protocol logic, the protocol logic to: receive a write request that is to reference a requesting agent, allocate an entry in the IODC to be associated with the write request without initiating a read or write to a memory to update directory state to be coupled to the receiving agent in response to the protocol agent receiving the write request; and initiate a write of data to the memory in response to receiving a write command that is to hit the entry in the IODC to be associated with the request, wherein the requesting agent is to implement a non-allocating write flow, and wherein the write command includes a write-back modified cache line transaction and a write-back of modified data to memory leaving an invalid copy in the requesting agent's cache, wherein the requesting agent is to implement an allocating write flow, and wherein the write command includes a write-back the modified cache line to memory and keep an exclusive copy of cache line transaction and a write-back exclusive data transaction, wherein write request includes a read of cache line ownership without needing data transaction, and wherein the protocol logic is to further initiate a snoop broadcast in response to receiving a read request that is to reference a second requesting agent, wherein the read request is to hit the entry of the IODC. In example 48, the subject matter of example 47 can optionally include an apparatus, wherein the protocol logic is to cause caching of the directory state of the cache line in the IODC until the data is written back to save directory lookup read and update write to memory for the read for ownership operation. In example 49, the subject matter of example 47 can optionally include an apparatus, wherein each entry of the IODC is to store a node identifier that identifies an input/output node. In example 50, the subject matter of example 49 can optionally include an apparatus, wherein one or more request transaction indexes from various node identifiers are to map to a same IODC entry.

In various embodiments of the invention, the operations discussed herein, e.g., with reference to FIGS. 1-6, may be implemented as hardware (e.g., circuitry), software, firmware, microcode, or combinations thereof, which may be provided as a computer program product, e.g., including a (e.g., non-transitory) machine-readable or (e.g., non-transitory) computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-6. Additionally, such computer-readable media may be downloaded as a computer program product, wherein the program may be transferred from a remote computer (e.g., a server) to a requesting computer (e.g., a client) through data signals in a carrier wave or other propagation medium via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic to cause a first agent, which is to receive a request to write data from a second agent via a link, to write a directory state of a cache line, corresponding to the data, to an Input/Output Directory Cache (IODC) of the first agent and write the data to a memory coupled to the first agent,
wherein writing the data from the second agent is to comprise a read for ownership operation and a write operation and wherein the read for ownership operation is to cache the directory state in the IODC and the write operation is to write back the data to the memory of the first agent and cause deallocation of the cache line from the IODC while keeping the cache line in a cache of the second agent in an exclusive state.

2. The apparatus of claim 1, wherein the logic is to cause caching of the directory state of the cache line in the IODC until the data is written back to save directory lookup read and update write to memory for the read for ownership operation.

3. The apparatus of claim 1, wherein each entry of the IODC is to store a node identifier that identifies an input/output node.

4. The apparatus of claim 3, wherein one or more request transaction indexes from various node identifiers are to map to a same IODC entry.

5. The apparatus of claim 4, wherein the node identifier and the one or more request transaction indexes are to be hashed to index into the IODC.

6. The apparatus of claim 1, wherein allocation into the IODC is to be controlled based on opportunistic snoop broadcast heuristics.

7. The apparatus of claim 1, wherein the first agent is to maintain a directory, the directory to store information about at which agent and in what state each cache line is cached.

8. The apparatus of claim 1, wherein the first agent is to comprise the logic.

9. The apparatus of claim 1, wherein the first agent and the second agent are on a same integrated circuit die.

10. The apparatus of claim 1, wherein the link is to comprise a point-to-point interconnect.

11. The apparatus of claim 1, wherein one or more of the first agent or the second agent are to comprise a plurality of processor cores.

12. The apparatus of claim 1, wherein one or more of the first agent or the second agent are to comprise a plurality of sockets.

13. The apparatus of claim 1, wherein the second agent is to comprise an I/O (TO) device.

14. A method comprising:
receiving at a first agent a request to write data from a second agent via a link; and
causing the first agent to write a directory state of a cache line, corresponding to the data, to an Input/Output Directory Cache (IODC) of the first agent and write the data to a memory coupled to the first agent,
wherein writing the data from the second agent comprises a read for ownership operation and a write operation and wherein the read for ownership operation caches the directory state in the IODC and the write operation writes back the data to the memory of the first agent and cause deallocation of the cache line from the IODC while keeping the cache line in a cache of the second agent in an exclusive state.

15. The method of claim 14, further comprising causing caching of the directory state of the cache line in the IODC until the data is written back to save directory lookup read and update write to memory for the read for ownership operation.

16. The method of claim 14, further comprising each entry of the IODC storing a node identifier that identifies an input/output node.

17. A computer-readable medium comprising one or more instructions that when executed on a processor configure the processor to perform one or more operations to:
receive at a first agent a request to write data from a second agent via a link; and
cause the first agent to write a directory state of a cache line, corresponding to the data, to an Input/Output Directory Cache (IODC) of the first agent and write the data to a memory coupled to the first agent,
wherein writing the data from the second agent comprises a read for ownership operation and a write operation and wherein the read for ownership operation caches the directory state in the IODC and the write operation writes back the data to the memory of the first agent and cause deallocation of the cache line from the IODC while keeping the cache line in a cache of the second agent in an exclusive state.

18. The computer-readable medium of claim 17, further comprising one or more instructions that when executed on the processor configure the processor to perform one or more operations to cause caching of the directory state of the cache line in the IODC until the data is written back to save directory lookup read and update write to memory for the read for ownership operation.

19. The computer-readable medium of claim 17, further comprising one or more instructions that when executed on the processor configure the processor to perform one or more operations to cause each entry of the IODC to store a node identifier that identifies an input/output node.

20. The computer-readable medium of claim 20, further comprising one or more instructions that when executed on the processor configure the processor to perform one or more operations to map one or more request transaction indexes from various node identifiers to a same IODC entry.

21. The computer-readable medium of claim 20, further comprising one or more instructions that when executed on the processor configure the processor to perform one or more operations to hash the node identifier and the one or more request transaction indexes to index into the IODC.

22. An apparatus comprising:
a receiving agent including an Input/Output Directory Cache (IODC) and protocol logic, the protocol logic to:
receive a write request that is to reference a requesting agent,
allocate an entry in the IODC to be associated with the write request without initiating a read or write to a memory to update directory state to be coupled to the receiving agent in response to the protocol agent receiving the write request; and
initiate a write of data to the memory in response to receiving a write command that is to hit the entry in the IODC to be associated with the request,
wherein the requesting agent is to implement a non-allocating write flow, and wherein the write command includes a write-back modified cache line transaction and a write-back of modified data to memory leaving an invalid copy in the requesting agent's cache,
wherein the requesting agent is to implement an allocating write flow, and wherein the write command includes a write-back the modified cache line to memory and keep an exclusive copy of cache line transaction and a write-back exclusive data transaction,
wherein write request includes a read of cache line ownership without needing data transaction, and
wherein the protocol logic is to further initiate a snoop broadcast in response to receiving a read request that is to reference a second requesting agent, wherein the read request is to hit the entry of the IODC.

23. The apparatus of claim 22, wherein the protocol logic is to cause caching of the directory state of the cache line in the IODC until the data is written back to save directory lookup read and update write to memory for the read for ownership operation.

24. The apparatus of claim 22, wherein each entry of the IODC is to store a node identifier that identifies an input/output node.

25. The apparatus of claim 24, wherein one or more request transaction indexes from various node identifiers are to map to a same IODC entry.
